(19) United States
(12) Patent Application Publication
(10) Pub. No.: US 2018/0137811 A1
(43) Pub. Date: May 17, 2018

(54) Driving circuit and operating method thereof

(71) Applicant: Raydium Semiconductor Corporation, Hsinchu (TW)

(72) Inventors: Hung LI, Taipei City (TW); Shang-Ping TANG, Zhubei City (TW)

(21) Appl. No.: 15/806,538

(22) Filed: Nov. 8, 2017

Related U.S. Application Data
(60) Provisional application No. 62/420,656, filed on Nov. 11, 2016.

(51) Int. Cl. G09G 3/3208

(52) U.S. Cl. CPC G09G 3/3208; G09G 2320/046; G09G 2340/12; G09G 2340/0464; G09G 2310/0291

(57) ABSTRACT

A driving circuit, disposed in a display and coupled to a display panel, includes a buffer module, a regenerating module, a data processing module and a driving module. The buffer module is used to receive and temporarily store a first image data. The regenerating module coupled to the buffer module is used to use the first image data to perform dynamic displaying process on an original image data according to a control signal to generate a second image data. The data processing module coupled to the regenerating module is used to perform data processing process on the second image data to generate an output image data. The driving module coupled to the data processing module and the display panel is used to output the output image data to the display panel. The dynamic displaying process is to dynamically superimpose the first image data on the original image data.

### BACKGROUND OF THE INVENTION

### 1. Field of the Invention

This invention relates to a display, especially to a driving circuit applied in a display and an operating method thereof.

### 2. Description of the Prior Art

In a conventional display apparatus having an OLED panel, the driving IC is usually used to receive image data inputted from outside and the digital image processing circuit is used to perform data process on the image data; and then, the processed image data is transmitted to the source driver and the source driver generates output voltage to the OLED panel.

In general, the driving IC usually has a memory to store the image data inputted from outside; for example, the driving circuit in FIG. 1 includes a buffer module 13 which can have a structure of frame buffer or line buffer. When the image data is not inputted from outside, the image data previously stored in the buffer module 13 can be transmitted to the OLED panel PL to display, so that the OLED panel PL can continuously display image without stopping.

Although the OLED panel PL will not stop displaying image due to no data inputted from outside, the OLED panel PL only statically display the image data previously stored in the buffer module 13 without any changes. In addition, as to the OLED panel PL, if the OLED panel PL continuously displays the same still image for a long period of time, the OLED panel PL will appear branded and its service life will be significantly reduced. The above-mentioned drawbacks in the prior arts should be overcome.

### SUMMARY OF THE INVENTION

Therefore, the invention provides a driving circuit applied and an operating method thereof to solve the above-mentioned problems.

An embodiment of the invention is a driving circuit. In this embodiment, the driving circuit is disposed in a display and coupled to a display panel. The driving circuit includes a buffer module, a regenerating module, a data processing module and a driving module. The buffer module is used for receiving a first image data and temporarily storing the first image data. The regenerating module is coupled to the buffer module and used for using the first image data to perform a dynamic displaying process on an original image data according to a control signal to generate a second image data. The data processing module is coupled to the regenerating module and used for performing a data processing process on the second image data to generate an output image data. The driving module is coupled to the data processing module and the display panel and used for outputting the output image data to the display panel. The dynamic displaying process includes dynamically superimposing the first image data on the original image data.

In an embodiment, the display panel is an organic light-emitting diode (OLED) display panel.

In an embodiment, the driving circuit further includes a transmission interface and another data processing module. The transmission interface is used for receiving an input image data from outside. The another data processing module is coupled between the input interface and the buffer module and used for performing the data processing process on the input image data to generate the first image data to the buffer module.

In an embodiment, the regenerating module includes a control unit and a regenerating unit. The control unit is used for generating the control signal according to an image position information of the first image data and a display position information of the display panel. The regenerating unit is coupled to the control unit and the data processing module respectively and used for receiving the original image data and generating the second image data to the data processing module according to the control signal, the first image data and the original image data.

In an embodiment, the image position information of the first image data includes a current position information, a target position information and a boundary information of the first image data.

In an embodiment, the regenerating module further includes a position information processing unit. The position information processing unit is coupled to the control unit and used for generating the image position information of the first image data according to a size information and a start displaying position information of the first image data.

In an embodiment, the first image data is displayed at a starting position and then orderly or randomly displayed at at least one motion trajectory coordinates along a dynamic moving path after a period of time, and the at least one motion trajectory coordinates is default coordinates or randomly generated coordinates.

In an embodiment, the dynamic moving path of the first image data has a regularity or non-regularity.

In an embodiment, the first image data is displayed at the starting position and the at least one motion trajectory coordinates or the first image data is displayed between the starting position and the at least one motion trajectory coordinates in a gradually moving way.

In an embodiment, after the first image data is displayed at the at least one motion trajectory coordinates, the first image data moves back to the starting position and starts looping.

Another embodiment of the invention is a driving circuit operating method. In this embodiment, the driving circuit operating method is used for operating a driving circuit disposed in a display. The driving circuit is coupled to a display panel. The driving circuit includes a buffer module, a regenerating module, a data processing module and a driving module. The regenerating module is coupled between the buffer module and the data processing module. The driving module is coupled between the data processing module and the display panel. The driving circuit operating method includes steps of: (a) the buffer module receiving a first image data and temporarily storing the first image data; (b) the regenerating module performing a dynamic displaying process on an original image data according to a control signal to generate a second image data; (c) the data processing module performing a data processing process on the second image data to generate an output image data; and (d) the driving module outputting the output image data to the display panel; wherein the dynamic displaying process includes dynamically superimposing the first image data on the original image data.

Compared to the prior art, the driving circuit and operating method thereof in the invention can add dynamic changing effects on the image displayed by the display panel without changing the displayed image; therefore, the OLED panel appearing branded caused by the OLED panel continuously displaying the same still image for a long period of time can be effectively avoid, and the service life of the OLED display panel can be significantly increased.

The advantage and spirit of the invention may be understood by the following detailed descriptions together with the appended drawings.

### BRIEF DESCRIPTION OF THE APPENDED DRAWINGS

FIG. 1 illustrates a schematic diagram of the driving circuit in the prior art.

FIG. 2 illustrates a functional block diagram of the driving circuit in an embodiment of the invention.

FIG. 3 illustrates a detailed functional block diagram of the regenerating module in FIG. 2.

FIG. 4A-FIG. 4C illustrate schematic diagrams of the OLED display panel, the original image data and the first image data respectively.

FIG. 5 illustrates a schematic diagram of using the first image data shown in FIG. 4C to perform dynamic displaying process on the original image data shown in FIG. 4B to obtain the second image data.

FIG. 6A-FIG. 6C illustrate schematic diagrams of the first image data displayed on the first position, the second position and the third position at the first time, the second time and the third time in order.

FIG. 7-FIG. 9 illustrate schematic diagrams of different moving trajectories of the dynamically displayed first image data respectively.

FIG. 10 illustrates a flowchart of the driving circuit operating method in another embodiment of the invention.

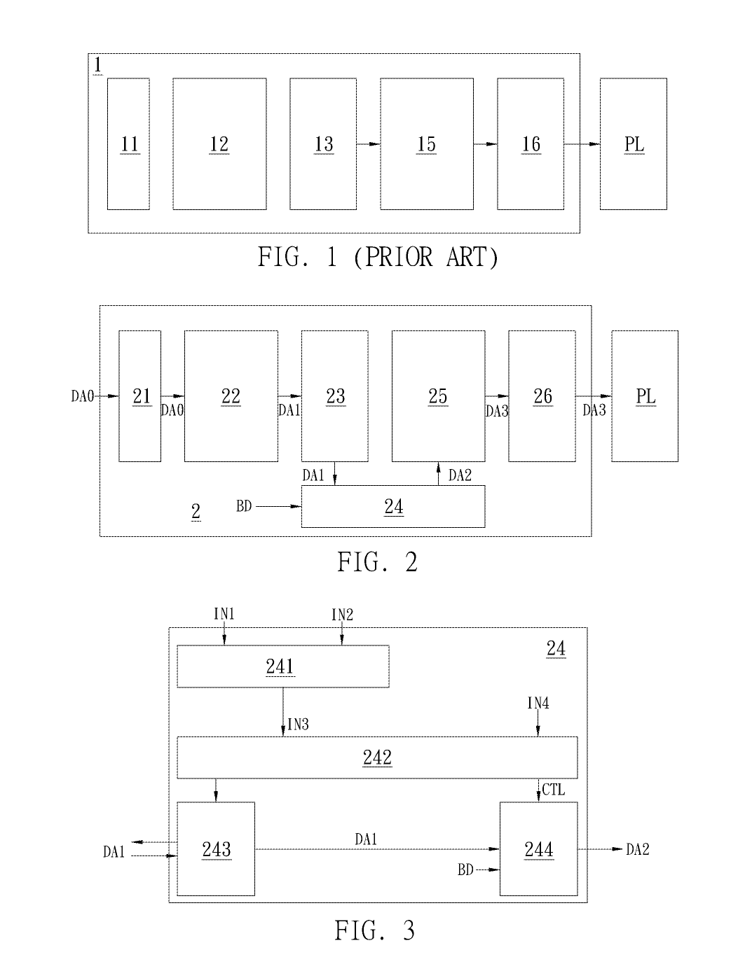

### DETAILED DESCRIPTION OF THE INVENTION

A preferred embodiment of the invention is a driving circuit. In this embodiment, the driving circuit is disposed in a display and coupled to an OLED display panel, but not limited to this.

Please refer to FIG. 2. FIG. 2 illustrates a functional block diagram of the driving circuit in this embodiment. As shown in FIG. 2, the driving circuit 2 is coupled to the OLED display panel PL. The driving circuit 2 includes a transmission interface 21, a first data processing module 22, a buffer module 23, a regenerating module 24, a second data processing module 25 and a driving module 26. Wherein, the first data processing module 22 is coupled between the transmission interface 21 and the buffer module 23; the regenerating module 24 is coupled between the buffer module 23 and the second data processing module 25; the driving module 26 is coupled between the second data processing module 25 and the OLED display panel PL.

In this embodiment, the buffer module 23 is used to receive a first image data DA1 and temporarily store the first image data DA1. It should be noticed that the transmission interface 21 can receive an input image data DA0 from outside and then the first data processing module 22 can perform data processing process on the input image data DA0 to generate the first image data DA1 and temporarily stored in the buffer module 23, or the first image data DA1 can be system default image data and temporarily stored in the buffer module 23 without specific limitations.

The regenerating module 24 is used to receive the first image data DA1 from the buffer module 23 and generate a second image data DA2 different from the first image data DA1 according to the first image data DA1 and then output the second image data DA2 to the second data processing module 25.

When the second data processing module 25 receives the second image data DA2 from the regenerating module 24, the second data processing module 25 will perform data processing process on the second image data DA2 to generate an output image data DA3 and then output the output image data DA3 to the driving module 26. Then, when the driving module 26 receives the output image data DA3 from the second data processing module 25, the driving module 26 will output the output image data DA3 to the OLED display panel PL.

It should be noticed that the regenerating module 24 in this embodiment can use the first image data DA1 to perform dynamic displaying process on the original image data BD according to the control signal to generate the second image data DA2. In fact, the dynamic displaying process can be dynamically superimposing the first image data DA1 on the original image data BD, but not limited to this.

Please refer to FIG. 3. FIG. 3 illustrates a detailed functional block diagram of the regenerating module 24 in FIG. 2. As shown in FIG. 3, the regenerating module 24 includes a position information processing unit 241, a control unit 242, a buffer control unit 243 and a regenerating unit 244. Wherein, the control unit 242 is coupled to the position information processing unit 241, the buffer control unit 243 and the regenerating unit 244 respectively; the buffer control unit 243 is coupled to the regenerating unit 244.

In this embodiment, the position information processing unit 241 is used for generating an image position information IN3 of the first image data DA1 according to a size information IN1 and a start displaying position information IN2 of the first image data DA1. In fact, the image position information IN3 of the first image data DA1 can include the current position information, the target position information and the boundary information of the first image data DA1, but not limited to this.

The control unit 242 not only receives the image position information IN3 of the first image data DA1 from the position information processing unit 241, but also receives a display position information IN4 of the OLED display panel PL. Thus, the control unit 242 can generate a control signal CTL according to the image position information IN3 of the first image data DA1 and the display position information IN4 of the OLED display panel PL and then output the control signal CTL to the regenerating unit 244.

The regenerating unit 244 receives not only the control signal CTL from the control unit 242, but also the first image data DA1 from the buffer control unit 243 and the original image data BD. Thus, the regenerating unit 244 can generate the second image data DA2 according to the control signal CTL, the first image data DA1 and the original image data BD and then output the second image data DA2 to the data processing module 25.

It should be noticed that the regenerating unit 244 can use the first image data DA1 to perform dynamic displaying process on the original image data BD according to the control signal CTL to generate the second image data DA2. For example, the regenerating unit 244 can dynamically superimpose the first image data DA1 on the original image data BD according to the control signal CTL to form the second image data DA2, but not limited to this.

In practical applications, when the regenerating unit 244 dynamically superimposes the first image data DA1 on the original image data BD, the first image data DA1 can be displayed at a starting position at first and then orderly or randomly displayed at the at least one motion trajectory coordinates after a period of time. And, the at least one motion trajectory coordinates can be default coordinates or randomly generated coordinates.

Next, please refer to different embodiments as follows.

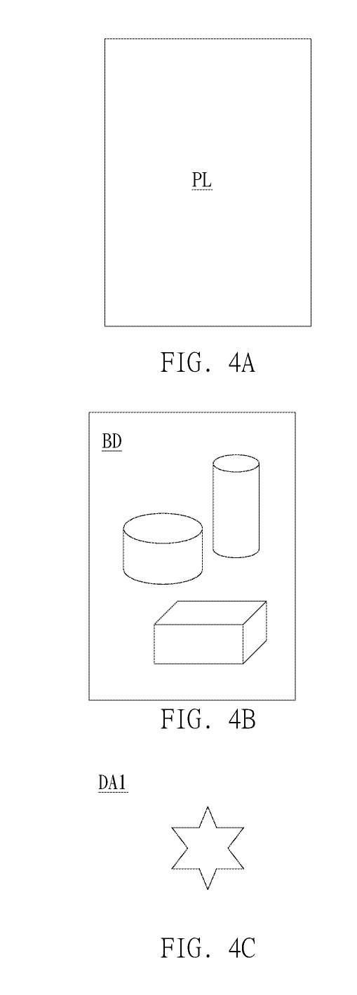

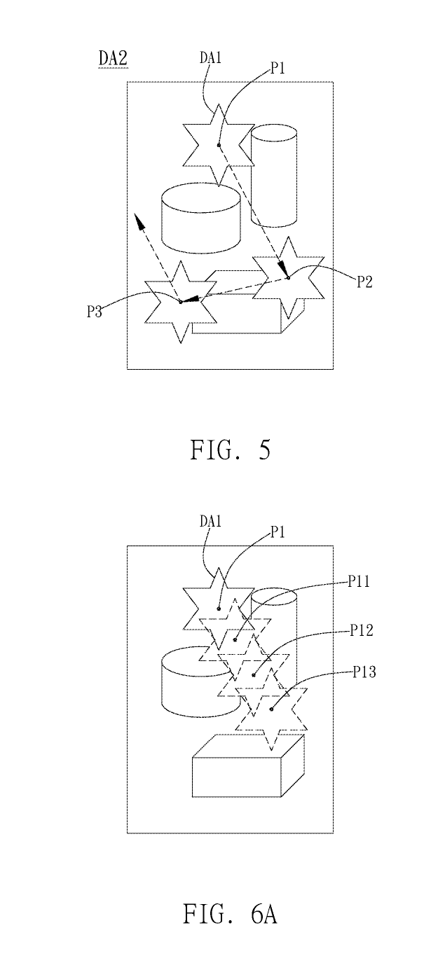

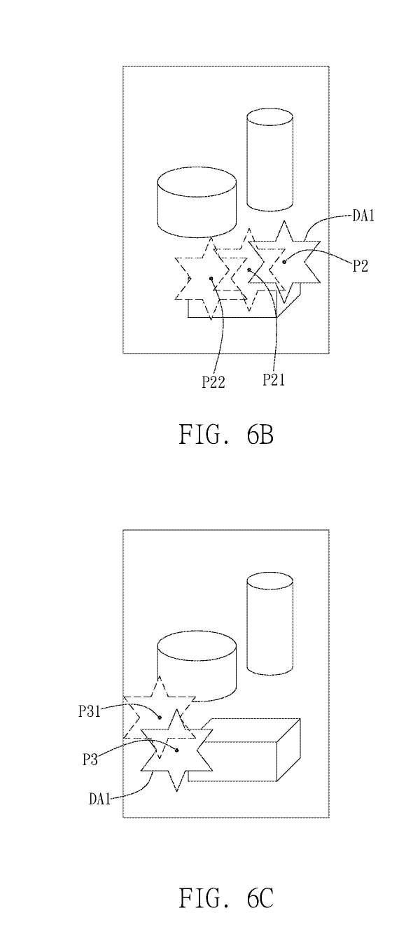

Please refer to FIG. 4A-FIG. 4C. FIG. 4A-FIG. 4C illustrate schematic diagrams of the OLED display panel PL, the original image data BD and the first image data DA1 respectively. Then, please also refer to FIG. 5. FIG. 5 illustrates a schematic diagram of using the first image data DA1 shown in FIG. 4C to perform dynamic displaying process on the original image data BD shown in FIG. 4B to obtain the second image data DA2. And, FIG. 6A-FIG. 6C illustrate schematic diagrams of the first image data DA1 displayed on the first position P1, the second position P2 and the third position P3 at the first time, the second time and the third time in order.

As shown in FIG. 5, the second image data DA2 is obtained by the regenerating unit 244 using the first image data DA1 shown in FIG. 4C to perform dynamic displaying process on the original image data BD shown in FIG. 4B according to the control signal CTL. For example, the regenerating unit 244 can dynamically superimpose the first image data DA1 on the original image data BD according to the control signal CTL to form the second image data DA2.

In detail, when the regenerating unit 244 dynamically superimposes the first image data DA1 on the original image data BD according to the control signal CTL, the first image data DA1 can be only displayed at the starting position (e.g., the first position P1) at first and the at least one motion trajectory coordinates (e.g., the second position P2 and the third position P3), or the first image data DA1 can be displayed between the starting position and the at least one motion trajectory coordinates in a gradually moving way. For example, as shown in FIG. 6A-FIG. 6C, the first image data DA1 can be not only displayed at the first position P1 and the second position P2, but also displayed at the displaying positions P11, P12 and P13 between the first position P1 and the second position P2 in the gradually moving way; similarly, the first image data DA1 can be not only displayed at the second position P2 and the third position P3, but also displayed at the displaying positions P21 and P22 between the second position P2 and the third position P3 in the gradually moving way, and so on.

It should be noticed that when the first image data DA1 is displayed in the gradually moving way, not only the first image data DA1 can be displayed at different positions, but also the first image data DA1 can have other changes (e.g., rotating an angle) to increase the variation of the image displayed by the OLED display panel PL. After the first image data DA1 is displayed at the last motion trajectory coordinates, the first image data DA1 can move back to the starting position (e.g., the first position P1) and start looping, but not limited to this.

In addition, if the buffer module 23 stores a plurality of first image data DA1, the regenerating module 24 can also orderly or randomly display the plurality of first image data DA1 in turn at the starting position and the at least one motion trajectory coordinates to increase the variation of the image displayed by the OLED display panel PL.

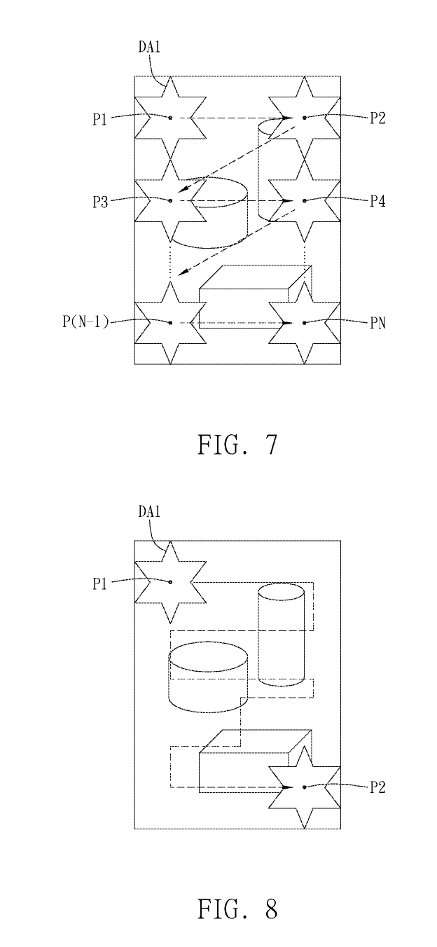

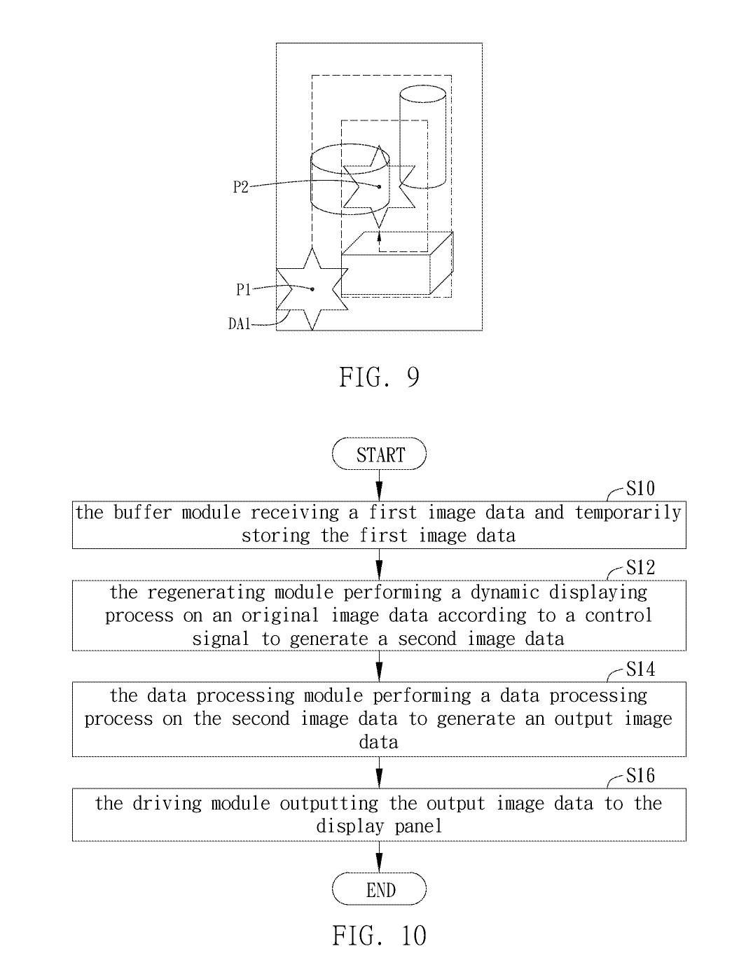

Please refer to FIG. 7-FIG. 9. FIG. 7-FIG. 9 illustrate schematic diagrams of different moving trajectories of the dynamically displayed first image data DA1 respectively. As shown in FIG. 7-FIG. 9, the first image data DA1 is displayed at the starting position (e.g., the first position P1) at first and then orderly or randomly displayed at the at least one motion trajectory coordinates (e.g., the second position P2, the third position P3, . . . , the (N−1)th position P(N−1) and the N-th position PN) along a dynamic moving path after a period of time. In fact, the coordinates of the displaying positions and the motion trajectory of the first image data DA1 at different times can be preset by system or randomly generated without specific limitations.

Another embodiment of the invention is a driving circuit operating method. In this embodiment, the driving circuit operating method is used for operating a driving circuit disposed in a display. The driving circuit is coupled to a display panel. The driving circuit includes a buffer module, a regenerating module, a data processing module and a driving module. The regenerating module is coupled between the buffer module and the data processing module. The driving module is coupled between the data processing module and the display panel.

Please refer to FIG. 10. FIG. 10 illustrates a flowchart of the driving circuit operating method in this embodiment. As shown in FIG. 10, the driving circuit operating method includes steps of:

Step S10: the buffer module receiving a first image data and temporarily storing the first image data;

Step S12: the regenerating module performing a dynamic displaying process on an original image data according to a control signal to generate a second image data;

Step S14: the data processing module performing a data processing process on the second image data to generate an output image data; and

Step S16: the driving module outputting the output image data to the display panel.

In practical applications, the dynamic displaying process can be dynamically superimposing the first image data on the original image data to generate some dynamic changes on the original image data to avoid the OLED panel appearing branded caused by the OLED panel continuously displaying the same still image for a long period of time, but not limited to this.

Compared to the prior art, the driving circuit and operating method thereof in the invention can add dynamic changing effects on the image displayed by the display panel without changing the displayed image; therefore, the OLED panel appearing branded caused by the OLED panel continuously displaying the same still image for a long period of time can be effectively avoid, and the service life of the OLED display panel can be significantly increased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A driving circuit, disposed in a display and coupled to a display panel, comprising:
a buffer module, for receiving a first image data and temporarily storing the first image data;
a regenerating module, coupled to the buffer module, for using the first image data to perform a dynamic displaying process on an original image data according to a control signal to generate a second image data;
a data processing module, coupled to the regenerating module, for performing a data processing process on the second image data to generate an output image data; and
a driving module, coupled to the data processing module and the display panel, for outputting the output image data to the display panel;
wherein the dynamic displaying process comprises dynamically superimposing the first image data on the original image data.

2. The driving circuit of claim 1, wherein the display panel is an organic light-emitting diode (OLED) display panel.

3. The driving circuit of claim 1, further comprising:
a transmission interface, for receiving an input image data from outside; and
another data processing module, coupled between the input interface and the buffer module, for performing the data processing process on the input image data to generate the first image data to the buffer module.

4. The driving circuit of claim 1, wherein the regenerating module comprises:
a control unit, used for generating the control signal according to an image position information of the first image data and a display position information of the display panel; and
a regenerating unit, coupled to the control unit and the data processing module respectively, for receiving the original image data and generating the second image data to the data processing module according to the control signal, the first image data and the original image data.

5. The driving circuit of claim 4, wherein the image position information of the first image data comprises a current position information, a target position information and a boundary information of the first image data.

6. The driving circuit of claim 4, wherein the regenerating module further comprises:
a position information processing unit, coupled to the control unit, for generating the image position information of the first image data according to a size information and a start displaying position information of the first image data.

7. The driving circuit of claim 1, wherein the first image data is displayed at a starting position and then orderly or randomly displayed at at least one motion trajectory coordinates along a dynamic moving path after a period of time, and the at least one motion trajectory coordinates is default coordinates or randomly generated coordinates.

8. The driving circuit of claim 7, wherein the dynamic moving path of the first image data has a regularity or non-regularity.

9. The driving circuit of claim 7, wherein the first image data is displayed at the starting position and the at least one motion trajectory coordinates or the first image data is displayed between the starting position and the at least one motion trajectory coordinates in a gradually moving way.

10. The driving circuit of claim 9, wherein after the first image data is displayed at the at least one motion trajectory coordinates, the first image data moves back to the starting position and starts looping.

11. A driving circuit operating method for operating a driving circuit disposed in a display, the driving circuit being coupled to a display panel, the driving circuit comprising a buffer module, a regenerating module, a data processing module and a driving module, the regenerating module is coupled between the buffer module and the data processing module, the driving module is coupled between the data processing module and the display panel, the driving circuit operating method comprising steps of:
(a) the buffer module receiving a first image data and temporarily storing the first image data;
(b) the regenerating module performing a dynamic displaying process on an original image data according to a control signal to generate a second image data;
(c) the data processing module performing a data processing process on the second image data to generate an output image data; and
(d) the driving module outputting the output image data to the display panel;
wherein the dynamic displaying process comprises dynamically superimposing the first image data on the original image data.

12. The driving circuit operating method of claim 11, wherein the display panel is an organic light-emitting diode (OLED) display panel.

13. The driving circuit operating method of claim 11, wherein the driving circuit further comprises a transmission interface and another data processing module, the transmission interface receives an input image data from outside and the another data processing module performs the data processing process on the input image data to generate the first image data to the buffer module.

14. The driving circuit operating method of claim 11, wherein the regenerating module comprises a control unit and a regenerating unit, the control unit generates the control signal according to an image position information of the first image data and a display position information of the display panel and the regenerating unit receives the original image data and generates the second image data to the data processing module according to the control signal, the first image data and the original image data.

15. The driving circuit operating method of claim 14, wherein the image position information of the first image data comprises a current position information, a target position information and a boundary information of the first image data.

16. The driving circuit operating method of claim 14, wherein the regenerating module further comprises a position information processing unit, the position information processing unit is coupled to the control unit and used for generating the image position information of the first image data according to a size information and a start displaying position information of the first image data.

17. The driving circuit operating method of claim 11, wherein the first image data is displayed at a starting position and then orderly or randomly displayed at at least one motion trajectory coordinates along a dynamic moving path after a period of time, and the at least one motion trajectory coordinates is default coordinates or randomly generated coordinates.

18. The driving circuit operating method of claim 17, wherein the dynamic moving path of the first image data has a regularity or non-regularity.

19. The driving circuit operating method of claim 17, wherein the first image data is displayed at the starting position and the at least one motion trajectory coordinates or the first image data is displayed between the starting position and the at least one motion trajectory coordinates in a gradually moving way.

20. The driving circuit operating method of claim 19, wherein after the first image data is displayed at the at least one motion trajectory coordinates, the first image data moves back to the starting position and starts looping.
